(19) United States
(12) Patent Application Publication
(10) Pub. No.: US 2009/0068403 A1
(43) Pub. Date: Mar. 12, 2009

(54) POLYIMIDE FILM AND COPPER-CLAD LAMINATE USING IT AS BASE MATERIAL

(75) Inventors: Naofumi Yasuda, Aichi (JP); Hiroki Ishikawa, Aichi (JP)

Correspondence Address: E I DU PONT DE NEMOURS AND COMPANY;LEGAL PATENT RECORDS CENTER, BARLEY MILL PLAZA 25/1122B, 4417 LANCASTER PIKE, WILMINGTON, DE, 19805, US

(73) Assignee: E.I. du Pont de Nemours and Company, Wilmington, DE (US)

(21) Appl. No.: 12/209,462

(22) Filed: Sep. 12, 2008

(30) Foreign Application Priority Data
Sep. 12, 2007 (JP) 2007-236205

(51) Int. Cl. B32B 3/30; C08G 73/10

(52) U.S. Cl. 428/141; 428/336; 528/310

(57) ABSTRACT

To provide a polyimide film, which has excellent size stability and is suitable for a substrate for fine pitch circuits, especially COF (Chip on Film) being wired at a narrow pitch in the width direction of the film, and a copper-clad laminate using the film as a base material.

### CROSS-REFERENCE TO RELATED APPLICATION

This application claims priority to Japanese patent application No. 2007-236205 filed Sep. 12, 2007.

### FIELD OF THE INVENTION

The present invention pertains to a polyimide film, which has excellent size stability and is suitable for a COF (Chip on Film) being wired, especially at a narrow film pitch, on a substrate for fine pitch circuits, and a copper-clad laminate using the film as a base material.

### BACKGROUND OF THE INVENTION

Along with the high miniaturization of flexible printed-circuit boards and semiconductor packages, the required items for polyimide films being used in them are also increased, and for example, small size change and curl due to cladding with a metal, high handling characteristic, etc., are mentioned. The polyimide film requires properties such as a thermal expansion coefficient equivalent to that of metals, high elastic modulus, and small size change due to the water absorption, and so a polyimide film has been developed in response to that.

For example, polyimide film using paraphenylenediamine are known to raise the elastic modulus (Patent references 1, 2, and 3). Also, examples of the polyimide film using biphenyltetracarboxylic dianhydride in addition to paraphenylenediamine are known to reduce size change due to water absorption while maintaining a high elasticity (Patent references 4 and 5).

Furthermore, in order to suppress size change in an attachment process with metal, a polyimide film in which the thermal expansion coefficient in the machine carrying direction (hereinafter, called MD) of the film is set so that it is smaller than the thermal expansion coefficient in the width direction (hereinafter, called TD) of the film and an anisotropy is rendered is described. In this example, a lamination method that carries out the attachment with a metal by roll to roll heating in an ordinary FPC process is adopted, and its purpose is to cancel a phenomenon in which an expansion is generated in the MD of the film in this process by tension, whereas contraction is generated in the TD (patent reference 6).

On the other hand, a two-layer type (a copper layer is directly formed on the polyimide film) without using an adhesive has recently been adopted as a copper-clad laminate in response to the miniaturization of wirings. In this type, there is a method for forming a copper layer on the film by plating and a method that casts polyamic acid onto a copper foil and imidates it. However, none of these methods was a thermocompression bonding process such as a lamination method. Thus, the necessity to make the thermal expansion coefficient of the MD in the film smaller than that in the TD disappeared, and in the COF usage in which the two-layer type was mainly adopted, a pattern being arranged at a narrow pitch in the TD of the film was conventional. On the contrary, if the thermal expansion efficient of the TD was large, the size between wirings was increased in bonding for chip mounting bonding, etc., so that the response to the demand for small chips was difficult. In order to address the demand, it is ideal to reduce the thermal expansion coefficient of the film to the degree that it approximates that of silicon, however since a thermal expansion difference from the copper is generated, a strain is generated in a heating process starting with bonding for chip mounting.

Patent reference 1: Japanese Kokai Patent Application No. Sho 60[1985]-210629

Patent reference 2: Japanese Kokai Patent Application No. Sho 64[1989]-16832

Patent reference 3: Japanese Kokai Patent Application No. Hei 1[1989]-131241

Patent reference 4: Japanese Kokai Patent Application No. Sho 59[1984]-164328

Patent reference 5: Japanese Kokai Patent Application No. Sho 61[1986]-111359

Patent reference 6: Japanese Kokai Patent Application No. Hei 4[1992]-25434

The present invention has been conducted based on the review results of the problems in the above-mentioned prior arts, and its purpose is to provide a polyimide film, which can reduce the size change of the film while maintaining the thermal expansion coefficient approximated to that of metals and is suitable for a substrate for fine pitch circuits such as COF, and a copper-clad laminate using the film as a base material.

### SUMMARY OF THE INVENTION

In order to achieve the above-mentioned purpose, the polyimide film of the present invention is characterized by the fact that at least 50 mol % or more 4,4-diaminobenzanilide represented by a formula (I) is used as a diamine component; and the thermal expansion coefficient α_{MD} in the machine carrying direction (MD) of the film and the thermal expansion coefficient α_{TD} in the width direction (TD) are in a range of 0-10 ppm/° C.

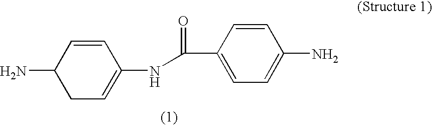

Furthermore, it is preferable for the polyimide film of the present invention to have the following (1)-(5).
(1) The tensile elastic modulus should be 5.0 GPa or more in both the machine carrying direction (MD) and the width direction (TD) of the film.
(2) The thermal contraction rate at 200° C. in both the machine carrying direction (TD) and the width direction (TD) of the film should be 0.05% or less.
(3) Inorganic particles with a particle diameter of 0.07-2.0 μm should be uniformly dispersed at a ratio of 0.03-0.30 wt % to the film resin weight into the film, and fine projections should be formed on the surface.
(4) The average particle diameter of the inorganic particles should be 0.10-0.90 μm, preferably 0.10-0.30 μm.
(5) The number of projections being formed by the inorganic particles should be 1×10³ to 1×10⁸ pieces per 1 mm².

Also, the copper-clad laminate of the present invention is characterized by the fact that any of the above-mentioned polyimide films is used as a base material and copper with a thickness of 1-10 μm is formed on it.

In the polyimide film of the present invention, with the use of the 4,4′-diamnobenzanilide, its thermal expansion coefficient can be suppressed low, and its high tensile elastic modulus is maintained.

### DETAILED DESCRIPTION OF THE PREFERRED EMBODIMENT(S)

In manufacturing the polyimide film of the present invention, first, a polyamic acid solution is obtained by polymerizing an aromatic diamine component and an acid anhydride component in an organic solvent.

As detailed examples of the above-mentioned aromatic diamines, 4,4′-diaminobenzanilide, paraphenylenediamine, metaphenylenediamine, benzidine, parxylylenediamine, 4,4′-diaminodiphenyl ether, 3,4′-diaminodiphenyl ether, 4,4′-diaminodiphenylmethane, 4,4′-diaminodiphenylsulfone, 3,3′-dimethyl-4,4′-diaminodiphenylmethane, 1,5-diaminonaphthalene, 3,3′-dimethoxybenzidine, 1,4-bis(3-methyl-5-aminophenyl)benzene, and these amide formative derivatives are mentioned. Among them, it is preferable for the finally obtained polyimide film to have a thermal expansion coefficient of 0-10 ppm/° C. and a tensile elastic modulus of 5.0 GPa or more for fine pitch substrates by adjusting the amount of diamine such as 4,4′-diaminobenzanilide, paraphenylenediamine, benzidine, 3,4′-diaminodiphenyl ether, which are effective for reducing the thermal expansion coefficient of the film.

Also, regarding the amount of addition of 4,4′-diaminobenzanilide, the thermal expansion coefficient is effectively lowered without sacrificing film manufacturability by adding 50 mol % or more, so that 0-10 ppmfC as described in the claims can be easily achieved. Generally, in order to lower the thermal expansion coefficient, a rigid diamine represented by paraphenylenediamine is required, however since the film manufacturability is lowered, the rigid diamine is not preferable.

As detailed examples of the above-mentioned acid anhydride component, acid anhydrides such as pyromellitic acid, 3,3′,4,4′-biphenyltetracarboxylic acid, 2,3′,3,4′-biphenyltetracarboxylic acid, 3,3′,4,4′-benzophenonetetracarboxylic acid, 2,3,6,7-naph-thalenecarboxylic acid, 2,2-bis(3,4-dicarboxyphenyl)ether, pyridine-2,3,5,6-tetracarboxylic acid, and these amide formative derivatives are mentioned.

Also, in the present invention, as detailed examples of the organic solvent being used for forming the polyamic acid solution, sulfoxide group solvent such as dimethyl sulfoxide and diethyl sulfoxide, formamide group solvent such as N-dimethylformamide and N,N-diethylformamide, acetamide group solvent such as N,N-dimethylacetamide and N,N-diethylacetamide, pyrrolidone group solvent such as N-methyl-2-pyrrolidone and N-vinyl-2-pyrrolidone, phenol group solvent such as phenol, o-, m-, or p-cresol, xylenol, phenol halide, and catechol, or nonprotic polar solvent such as hexamethyl phosphoramide and γ-butyrolactone can be mentioned. Preferably, they can be used alone or as a mixture, and an aromatic hydrocarbon such as xylene and toluene can also be used.

The polymerization method may be carried out by any of several well-known methods. For example:
(1) A method that puts the total amount of aromatic diamine component into a solvent, adds an aromatic tetracarboxylic acid component to it so that its amount is equivalent to the total amount of aromatic diamine component, and polymerizes them.
(2) A method that puts the total amount of aromatic tetracarboxylic acid component into a solvent, adds an aromatic diamine component so that its amount is equivalent to the aromatic tetracarboxylic acid, and polymerizes them.
(3) A method that puts one aromatic diamine component into a solvent, mixes an aromatic tetracarboxylic acid component at a ratio of 95-105 mol % with the reaction component for the time required for the reaction, adds another aromatic diamine component, adds an aromatic tetracarboxylic acid component so that the total aromatic diarrine component and the total aromatic tetracarboxylic acid components are almost an equal amount, and polymerizes them.
(4) A method that puts an aromatic tetracarboxylic acid component into a solvent, mixes one aromatic diamine component at a ratio of 95-105 mol % with the reaction component for the time required for the reaction, adds an aromatic tetracarboxylic acid component, adds another aromatic diamine component so that the total aromatic diamine component and the total aromatic tetracarboxylic acid component are almost an equal amount, and polymerizes them.
(5) A method that adjusts a polyamide acid solution (A) by reacting one aromatic diamine component and aromatic tetracarboxylic acids in a solvent so that one of them is excessive, adjusts a polyamide acid solution (B) by reacting another aromatic diamine component and aromatic tetracarboxylic acids in another solvent so that one of them is excessive, mixes the respective polyamide acid solutions (A) and (B) obtained in this manner, and completes the polymerization. At that time, in adjusting the polyamide acid solution (A), if the aromatic diamine component is excessive, the aromatic tetracarboxylic acid component is excessive in the polyamide acid solution (B), and if the aromatic tetracarboxylic acid component is excessive in the polyamide acid solution (A), the aromatic diamine component is excessive in the polyamide acid solution (B). The polyamide acid solutions (A) and (B) are mixed, and the total aromatic diamine component and the total aromatic tetracarboxylic acid component being used in these reactions are adjusted to a nearly equal amount.

Also, the polymerization method is not limited to these methods, and other well-known methods may also be employed. The polyamic acid solution obtained in this manner includes a solid fraction of 5-40 wt %, preferably 10-30 wt %. Also, for a stable solution feed, its viscosity is set to 10-2,000 Pa·s, preferably 100-1,000 Pa·s as a measured value of a Brookfield viscometer. Also, the polyamic acid in the organic solvent solution may also be partially imitaded.

Next, the method for manufacturing the polyimide film of the present invention is explained.

As the method for manufacturing the polyimide film, a method that casts a polyamic acid solution in a film shape and obtains a polyimide film by thermally decyclizing and removing the solvent and a method that mixes a polyamic acid solution with a cyclization catalyst and a dehydrator, prepares a gel film by chemically decyclizing, and obtains a polyimide film by heating it and removing the solvent are mentioned. The latter method is preferable since the thermal expansion coefficient of the polyimide film being obtained can be greatly suppressed.

Also, the polyamic acid solution can chemically include inactive inorganic particles such as titanium oxide, fine silica, calcium carbonate, calcium phosphate, calcium hydrogen phosphate, and polyimide filler. Among them, it is preferable to form fine projections by uniformly dispersing fine silica with a particle diameter of 0.07-2.0 μm at a ratio of 0.03-0.30 wt % to the film resin weight. The particle diameter in a range of 0.07-2.0 μm is preferable since the inspection in an automatic engineering inspection system of said polyimide film can be applied without a problem. As the amount of addition, if the amount of more than 0.30 wt %, mechanical strength decreases, and if the amount is less than 0.03 wt %, a sufficient easy sliding effect does not happen, which is undesirable. Also, the average particle diameter is preferably 0.10-0.90 μm, more preferably 0.10-0.30 μm. If the average particle diameter is smaller than 0.10 μm, the easy sliding effect of the film decreases, which is not preferable. If the average particle diameter is greater than 0.90 μm, large particles are locally present, which is not preferable.

The above-mentioned polyamic acid solution can include a cyclization catalyst (imidation catalyst), dehydrator, gelation retarder, etc.

As detailed examples of the cyclization catalyst being used in the present invention, aliphatic tertiary amine such as trimethylamine and triethylenediamine, aromatic tertiary amine such as dimethylaniline, heterocyclic tertiary amine such as isoquinoline, pyridine, and beta picoline, etc., are mentioned, and at least one kind of amine being selected from heterocyclic tertiary amines is preferably used.

As detailed examples of the dehydrator being used in the present invention, aliphatic carboxylic anhydride such as acetic anhydride, propionic anhydride, and lactic anhydride, aromatic carboxylic anhydride such as benzoic anhydride, etc., are mentioned, and acetic anhydride and/or benzoic anhydride are preferable.

As the method for manufacturing the polyimide film from the polyamic acid solution, the polyamic acid solution containing a cyclization catalyst and a dehydrator is cast on a support from a spinneret with a slit, molded into a film shape, changed to a gel film with a self-support characteristic by partially advancing the imidation on the support, peeled from the support, heated and dried/imidated, and heat-treated.

The above-mentioned polyamic acid solution is molded into a film shape through the spinneret with a slit, cast on the heated support, subjected to a thermal closed-ring reaction on the support, and peeled off as a gel film with a self-support characteristic from the support.

The above-mentioned support is a rotary drum or endless belt made of a metal, and its temperature is controlled by a liquid or gas heat medium and/or a liquid or gas heat medium with radiant heat such as an electric heater and/or the radiant heat from an electric heater.

The above-mentioned gel film is heated to 30-200° C., preferably 40-150° C., by receiving heat from the support and/or a heat source, such as hot air or an electric heater, and subjected to a ring-closing reaction, so that volatile portions such as free organic solids are dried, and the gel film has a self-support characteristic, thereby peeling off from the support.

The gel film peeled off from the above-mentioned support is stretched in the running direction through the regulation of the running speed by a rotary roll while drying the solvent of the film (drying zone). The stretch magnitude (MDX) in the machine carrying direction is set to 1.01-1.9 times, preferably 1.05-1.6 times, and more preferably 1.05-1.4 times at a temperature of 140° C. or lower. The gel film stretched in the carrying direction is introduced into a tenter apparatus, and its both ends are gripped by tenter grips. The gel film is stretched in the width direction while rinning along with the tenter grips. At that time, the stretch magnitude in the width direction (TD) is set so that it is higher than the stretch magnitude in the machine carrying direction (MD) of the film. Specifically, with the setup of the stretch magnitude in the width direction to 1.1-1.5 times the stretch magnitude in the machine carrying direction, a film oriented in the film TD, that is, a film can be obtained in which the thermal expansion coefficient in the film TD is greatly suppressed while maintaining the thermal expansion coefficient approximated to metals in the film MD. With the adjustment of the stretch magnitude of both of them in these ranges, the thermal expansion coefficient αMD in the MD of the film is preferably in a range of 3-10 ppm/° C., and the thermal expansion coefficient αTD in the TD of the film is preferably in a range of 3-10 ppm/° C. αMD is more preferably in a range of 0-10 ppm/° C., and αTD is more preferably in a range of 0-10 ppm/° C.

The film dried in the drying zone is heated for 15 sec-10 min by hot air, infrared heater, etc. Then, the film is heat-treated at a temperature of 250-500° C. for 15 sec-20 sec by hot air and/or electric heater, etc.

Also, the thickness of the polyimide film is adjusted by adjusting the running speed, and the film of the polyimide film is preferably 3-250 μm. Thus, if the thickness of the film is thickener or thinner than this range, the film manufacturability is considerably deteriorated, which is not preferable.

Preferably, the polyimide film obtained in this manner is further annealed at a temperature of 200-500° C. Thus, the heat relaxation of the film is caused, and the thermal contraction rate can be greatly suppressed. In the method for manufacturing the polyimide film of the present invention, since the orientation in the film TD is strong, the thermal contraction rate in this direction is apt to be raised as much, however since the thermal contraction rate at 200° C. can be suppressed to 0.05% or less in both the MD and the TD of the film by the heat relaxation from the annealing treatment, the size precision is further raised, which is preferable. Specifically, the film is run under low tension and annealed in a furnace at 200-500° C. The residence time of the film in the furnace is the treatment time, and the treatment time is controlled by changing the running speed. The treatment time is preferably 30 sec-5 min. If the treatment time is shorter than this range, sufficient heat is not transferred to the film, and if the treatment time is long, overheating is apt to be caused, so that the flatness is damaged, which is not preferable. Also, the film tension during running is preferably 10-50 N/m, more preferably 20-30 N/m. If the tension is lower than this range, the runnability of the film is deteriorated, and if the tension is higher than this range, the thermal contraction rate in the running direction of the film is raised, which is not preferable.

Also, in order to ensure adhesion to the polyimide film, an electric treatment such as corona treatment and plasma treatment or a physical treatment such as blast treatment may also be applied to the film surface.

A method for directly forming copper on the polyimide film by sputtering or plating and a method for tension-attaches a copper foil via an adhesive onto the polyimide film are mentioned; the former method is preferable since the copper thickness can be controlled, the size stability is favorable, and the reliability is high in terms of electric properties.

The polyimide film being obtained in this manner and the copper-clad laminate using the film as a base material are oriented in the TD of the film, so that the thermal expansion coefficient in this direction can be kept low and the thermal expansion coefficient in the MD has a value approximated to those of metals. Furthermore, the thermal contraction rate is low, and the tensile elastic modulus is high. Thus, this polyimide film is suitable for use as a substrate for fine pitch circuits, especially for COF (Chip on Film) being wired at a narrow pitch in the TD of the film.

### EXAMPLES

Next, the present invention is explained in detail by application examples.

Also, ABA in the application examples represents 4,4′-diaminobenzanilide, PPD represents paraphenylenediamine, 4,4′-ODA represents 4,4′-diaminodiphenyl ether, 3,4′-ODA represents 3,4′-diaminodiphenyl ether, PMDA represents pyromellitic dianhydride, BPDA represents 3,3′,4,4′-diphenyltetracarboxylic dianhydride, and DMAc represents N,N-dimethylacetamide. Also, each characteristic in the application examples was evaluated by the following methods.

(1) Thermal Expansion Coefficient

Using TMA-50 made by Shimadzu Corporation, the thermal expansion coefficient was measured under the conditions of a measurement temperature of 50-200° C. and a temperature rise rate of 10° C./min.

(2) Tensile Elastic Modulus

Using RTM-250 made by A & D, the tensile elastic modulus was measured under the condition of a tensile speed of 100 mm/min.

(3) Particle Size Distribution

Using SALD-2000 J made by Shimadzu Corporation, a sample dispersed into DMAc was measured.

(4) Number of Projections

Using a ultrahigh-resolution field emission type scanning electron microscope (UHR-FE-SEM) S-5000 made by Hitachi, Ltd., a 10,000-times SEM photograph of the film surface was taken, and projections were counted. Also, Pt was coated as a SEM pretreatment.

(5) Friction Coefficient (Static Friction Coefficient)

The friction coefficient was measured according to JIS K-7125. In other words, using a slip coefficient measurer Slip Tester (made by Techno Needs K.K.), the treated surfaces of the film were superposed, and a weight of 200 g was placed on it. One side of the film was fixed, and the other side was pulled out at 100 mm/min. Then, the friction coefficient was measured.

(6) Size Change Rate and Curl after a Solder Bath Treatment of the Film on which a Copper Wire was Formed:

(i) On a film 35 mm in width (TD)×120 mm in width (MD), a nickel/chromium alloy (nickel/chromium=95/5) was sputtered, so that a nickel/chromium layer with a thickness of 0.03 μm was formed. Then, copper was sputtered on the nickel/chromium alloy layer, so that a copper layer with a thickness of 0.1 μm was formed. Using the copper layer thus formed as an electrode, electroplating was carried out with a copper sulfate plating solution (200 g copper sulfate pentahydrate, 100 g sulfuric acid, 0.10 mL hydrochloric acid, 17 mL additive for copper sulfate plating made by Nippon Rironal, and 1,000 L water), so that a copper layer with a thickness of 8 μm was finally formed.

(ii) Photoresist Pattern Formation

On the copper layer with a thickness of 8 μm obtained, a photoresist AZP4620 made by Clariant Japan Ltd. was spread at 1,000 rpm×5 sec×1,600 rpm×30 sec by a spin coater (1H-360S made by Mikasa K.K.). Then, it was dried at 105° C. for 20 min in an oven, and the solvent in the photoresist was removed. The photoresist layer formed had a thickness of 9 μm.

Next, the photoresist layer formed was exposed using a photomask. A photomask was used in which 50 pieces of wirings with a pitch of 100 μm (a wiring width of 55 μm/a wiring interval of 45 μm) were formed in the TD direction. The amount of exposure was 400 mJ/cm².

After exposing, an aqueous solution of AZ400K/water=90/10 (weight ratio) was mixed using a photoresist developing solution AZ400K made by Clariant Japan Ltd., and using the mixed solution as a developing solution, immersing at 25° C. for 4 min and agitating and developing were carried out, so that an intended photoresist with a wiring shape of a pitch of 100 μm was formed.

(iii) Copper Etching

After forming a photoresist in a wiring shape, an etching treatment was carried out at 40° C. for 2 min with 35 wt % aqueous iron chloride solution as a copper etching solution while showering the copper etching solution from a spray nozzle, and a copper layer was patterned at a pitch of 100 μm (a wiring width of 50 μm/a wiring interval of 50 μm). After the copper etching, immersing two times at 25° C. for 5 min and agitating and washing with water were carried out, and a natural drying was carried out.

(iv) Photoresist Removal

After forming a copper wiring, immersing at 25° C. for 3 min and agitating and peeling-off were carried out using an aqueous solution of 2.5 wt % sodium hydroxide, and the photoresist was dissolved and removed. After removing the photoresist, immersing two times at 25° C. for 5 min and agitating and washing with water were carried out, and a natural drying was carried out.

(v) Tinplating

After removing the photoresist, an electroless tinplating was carried out using an electroless tinplating solution LT34 made by Shipray Far East Co. by immersing at 25° C. for 2 min. After the electroless tinplating, immersing of two times at 25° C. for 5 min and agitating and washing with water were carried out, and a natural drying was carried out.

(vi) Size Change Rate and Curl Measurement

After tinplating, the size in the TD direction was measured (L3). Then, immersing was carried out for 30 sec in a solder bath at 250° C., and after immersing, the size in the TD direction was re-measured (L4). The size change rate before and after the treatment with the solder bath was attained by the following equation.

Size change rate(%)=(L4−L3)/L3×100

Also, regarding curl, a sample was put in a still state in a flat place after the treatment with the solder bath, and the amount of warp from the floor of the end of the sample was evaluated as “curl.”

### Application Example 1

26.66 g (117 mmol) 4,4′-diaminobenzanilide and 195.48 g N,N-dimethylacetamide were put into a 500 mL separable flask with a DC stirrer and stirred at room temperature in a nitrogen atmosphere. 33.47 g (114 mmol) 3,3′,4,4′-biphenyltetracarboxylic acid was charged for 30 min-3 h by dividing it into several times. Using 20 mL N,N-dimethylacetamide, 3,3′,4,4′-biphenyltetracarboxylic acid attached to a powder funnel was washed and put into the reaction system. After stirring for 1 h, 25.58 g N,N-dimethylacetamide pyromelliticdianhydride solution (6 wt %) was dropped for 30 min and further stirred for 1 h, so that a polyamic acid was obtained.

Next, 0.03 wt % silica with an average diameter of 0.30 μm, from which particle diameters smaller than 0.08 μm or greater than 2 μm were excluded, was added to it and sufficiently stirred and dispersed.

Then, the polyamic acid solution was cooled to −5° C., and 15 wt % acetic anhydride and 15 wt % β-picoline were mixed with 100 wt % polyamic acid solution, so that the polyamic acid was imidated.

The polyimide polymer obtained in this manner was cast for 30 sec on a rotary drum at 90° C., and the gel film obtained was stretched 1.1 times in the running direction while heating 100° C. for 5 min. Then, its both ends in the width direction were gripped, and the film was stretched 1.5 times in the width direction while heating at 270° C. for 2 min and then heated at 380° C. for 5 min, so that a polyimide film with a thickness of 38 μm was obtained. The polyimide film was tensioned at 20 N/m in a furnace set to 220° C. and annealed for 1 min, and its respective characteristics were evaluated and described in Table 1.

### Application Example 2

8.81 g (39 mmol) 4,4′-diaminobenzanilide and 84.73 g N,N-dimethylacetamide were put into a 500 mL separable flask with a DC stirrer and stirred at room temperature in a nitrogen atmosphere. 11.06 g (38 mmol) 3,3′,4,4′-biphenyltetracarboxylic acid was charged for 30-50 min by dividing it several times. Using 10 mL N,N-dimethylacetamide, 3,3′,4,4′-biphenyltetracarboxylic acid attached to a powder funnel was washed and put into the reaction system. After stirring for 1 h, 2.79 g (26 mmol) p-phenylenediamine was added to it, and 7.37 g (25 mmol) 3,3′,4,4′-biphenyltetracarboxylic acid was charged into it for 10 min. Using 10 mL N,N-dimethylacetamide, 3,3′,4,4′-biphenyltetracarboxylic acid attached to the powder funnel was washed and put into the reaction system. After stirring for 12 h, 10.04 g N,N-dimethylacetamide pyromelliticdianhydride solution (6 wt %) was dropped for 30 min and further stirred for 1 h, so that a polyamic acid was obtained.

Next, 0.03 wt % silica with an average diameter of 0.30 μm, from which particle diameters smaller than 0.08 μm or greater than 2 μm were excluded, was added to it and sufficiently stirred and dispersed.

Then, the polyamic acid solution was cooled to −5° C., and 15 wt % acetic anhydride and 15 wt % β-picoline were mixed with 100 wt % polyamic acid solution, so that the polyamic acid was imidated.

The polyimide polymer obtained in this manner was cast for 30 sec on a rotary drum at 90° C., and the gel film obtained was stretched 1.1 times in the running direction while heating 100° C. for 5 min. Then, both of its ends in the width direction were gripped, and the film was stretched 1.5 times in the width direction while heating at 270° C. for 2 min, and then heated at 380° C. for 5 min, so that a polyimide film with a thickness of 38 μm was obtained. The polyimide film was tensioned at 20 N/m in a furnace set to 220° C. and annealed for 1 min, and its respective characteristics were evaluated and described in Table 1.

### Application Example 3

9.23 g (41 mmol) 4,4′-diaminobenzanilide and 84.41 g N,N-dimethylacetamide were put into a 500 mL separable flask with a DC stirrer and stirred at room temperature in a nitrogen atmosphere. 8.59 g (39 mmol) pyromellitic dianhydride was charged for 30-50 min by dividing it several times. Using 5 mL N,N-dimethylacetamide, pyromellitic acid attached to a powder funnel was washed and put into the reaction system. After stirring for 2 h, 5.42 g (27 mmol) 4,4′-diaminodiphenyl ether and 5 mL N,N-dimethylacetamide were added to it. 3.98 g (14 mmol) 3,3′,4,4′-biphenyltetracarboxylic acid was charged by dividing it several times. Using 10 mL N,N-dimethylacetamide, 3,3′,4,4′-biphenyltetracarboxylic acid attached to the powder funnel was washed and put into the reaction system. After stirring for 30 min, 2.78 g (13 mmol) pyromellitic dianhydride was charged by dividing it several times. Using 10 mL N,N-dimethylacetamide, the pyromellitic acid attached to the powder funnel was washed and put into the reaction system.

After stirring for 16 h, 14.77 g N,N-dimethylacetamide pyromelliticdianhydride solution (6 wt %) was dropped for 30 min and further stirred for 1 h, so that a polyamic acid was obtained. Next, 0.03 wt % silica with an average diameter of 0.30 μm, from which particle diameters smaller than 0.08 μm or greater than 2 μm were excluded, was added to it and sufficiently stirred and dispersed. Then, the polyamic acid solution was cooled to −5° C., and 15 wt % acetic anhydride and 15 wt % β-picoline were mixed with 100 wt % polyamic acid solution, so that the polyamic acid was imidated.

The polyimide polymer obtained in this manner was cast for 30 sec on a rotary drum at 90° C., and the gel film obtained was stretched 1.1 times in the running direction while heating at 100° C. for 5 min. Then, both of its ends in the width direction were gripped, and the film was stretched 1.5 times in the width direction while heating at 270° C. for 2 min and then heated at 380° C. for 5 min, so that a polyimide film with a thickness of 38 μm was obtained. The polyimide film was tensioned at 20 N/m in a furnace set to 220° C. and annealed for 1 min, and its respective characteristics were evaluated and described in Table 1.

### Application Example 4

26.66 g (117 mmol) 4,4′-diaminobenzanilide and 195.48 g N,N-dimethylacetamide were put into a 500 mL separable flask with a DC stirrer and stirred at room temperature in a nitrogen atmosphere. 33.47 g (114 mmol) 3,3′,4,4′-biphenyltetracarboxylic acid was charged for 30 min-3 h by dividing it several times. Using 20 mL N,N-dimethylacetamide, 3,3′,4,4′-biphenyltetracarboxylic acid attached to a powder funnel was washed and put into the reaction system. After stirring for 1 h, 25.58 g N,N-dimethylacetamide pyromelliticdianhydride solution (6 wt %) was dropped for 30 min and further stirred for 1 h, so that a polyamic acid was obtained. Next, 0.10 wt % silica with an average diameter of 0.30 μm, from which particle diameters smaller than 0.08 μm or greater than 2 μm were excluded, was added to it and sufficiently stirred and dispersed. Then, the polyamic acid solution was cooled to −5° C., and 15 wt % acetic anhydride and 15 wt %-picoline were mixed with 100 wt % polyamic acid solution, so that the polyamic acid was imidated.

The polyimide polymer obtained in this manner was cast for 30 sec on a rotary drum at 90° C., and the gel film obtained was stretched 1.1 times in the running direction while heating 100° C. for 5 min. Then, both of its ends in the width direction were gripped, and the film was stretched 1.5 times in the width direction while heating at 270° C. for 2 min and then heated at 380° C. for 5 min, so that a polyimide film with a thickness of 38 μm was obtained. The polyimide film was tensioned at 20 N/m in a furnace set to 220° C. and annealed for 1 min, and its respective characteristics were evaluated and described in Table 2.

### Application Example 5

8.81 g (39 mmol) 4,4′-diaminobenzanilide and 84.73 g N,N-dimethylacetamide were put into a 500 mL separable flask with a DC stirrer and stirred at room temperature in a nitrogen atmosphere. 11.06 g (38 mmol) 3,3′,4,4′-biphenyltetracarboxylic acid was charged for 30-50 min by dividing it several times. Using 10 mL N,N-dimethylacetamide, 3,3′,4,4′-biphenyltetracarboxylic acid attached to a powder funnel was washed and put into the reaction system. After stirring for 1 h, 2.79 g (26 mmol) p-phenylenediamine was added to it, and 7.37 g (25 mmol) 3,3′,4,4′-biphenyltetracarboxylic acid was charged for 10 min into it. Using 10 mL N,N-dimethylacetamide, 3,3′,4,4′-biphenyltetracarboxylic acid attached to the powder funnel was washed and put into the reaction system. After stirring for 12 h, 10.04 g N,N-dimethylacetamide pyromelliticdianhydride solution (6 wt %) was dropped for 30 min and further stirred for 1 h, so that a polyamic acid was obtained. Next, 0.10 wt % silica with an average diameter of 0.30 μm, from which particle diameters smaller than 0.08 μm or greater than 2 μm were excluded, was added to it and sufficiently stirred and dispersed. Then, the polyamic acid solution was cooled to −5° C., and 15 wt % acetic anhydride and 15 wt % β-picoline were mixed with 100 wt % polyamic acid solution, so that the polyamic acid was imidated.

The polyimide polymer obtained in this manner was cast for 30 sec on a rotary drum at 90° C., and the gel film obtained was stretched 1.1 times in the running direction while heating 100° C. for 5 min. Then, both of its ends in the width direction were gripped, and the film was stretched 1.5 times in the width direction while heating at 270° C. for 2 min and then heated at 380° C. for 5 min, so that a polyimide film with a thickness of 38 μm was obtained. The polyimide film was tensioned at 20 N/m in a furnace set to 220° C. and annealed for 1 min, and its respective characteristics were evaluated and described in Table 2.

### Application Example 6

9.23 g (41 mmol) 4,4′-diaminobenzanilide and 84.41 g N,N-dimethylacetamide were put into a 500 mL separable flask with a DC stirrer and stirred at room temperature in a nitrogen atmosphere. 8.59 g (39 mmol) pyromellitic dianhydride was charged for 30-50 min by dividing it several times. Using 5 mL N,N-dimethylacetamide, pyromellitic acid attached to a powder funnel was washed and put into the reaction system. After stirring for 2 h, 5.42 g (27 mmol) 4,4′-diaminodiphenyl ether and 5 mL N,N-dimethylacetamide were added to it. 3.98 g (14 mmol) 3,3′,4,4′-biphenyltetracarboxylic acid was charged by dividing it several times. Using 10 mL N,N-dimethylacetamide, 3,3′,4,4′-biphenyltetracarboxylic acid attached to the powder funnel was washed and put into the reaction system. After stirring for 30 min, 2.78 g (13 mmol) pyromellitic dianhydride was charged by dividing it into several times. Using 10 mL N,N-dimethylacetamide, the pyromellitic acid attached to the powder funnel was washed and put into the reaction system.

After stirring for 16 h, 14.77 g N,N-dimethylacetamide pyromelliticdianhydride solution (6 wt %) was dropped for 30 min and further stirred for 1 h, so that a polyamic acid was obtained. Next, 0.10 wt % silica with an average diameter of 0.30 μm, from which particle diameters smaller than 0.08 μm or greater than 2 μm were excluded, was added to it and sufficiently stirred and dispersed. Then, the polyamic acid solution was cooled to −5° C., and 15 wt % acetic anhydride and 15 wt % β-picoline were mixed with 100 wt % polyamic acid solution, so that the polyamic acid was imidated.

The polyimide polymer obtained in this manner was cast for 30 sec on a rotary drum at 90° C., and the gel film obtained was stretched 1.1 times in the running direction while heating 100° C. for 5 min. Then, both of its ends in the width direction were gripped, and the film was stretched 1.5 times in the width direction while heating at 270° C. for 2 min and then heated at 380° C. for 5 min, so that a polyimide film with a thickness of 38 μm was obtained. The polyimide film was tensioned at 20 N/m in a furnace set to 220° C. and annealed for 1 min, and its respective characteristics were evaluated and described in Table 2.

### Application Example 7

26.66 g (117 mmol) 4,4′-diaminobenzanilide and 195.48 g N,N-dimethylacetamide were put into 500 mL separable flask with a DC stirrer and stirred at room temperature in a nitrogen atmosphere. 33.47 g (114 mmol) 3,3′,4,4′-biphenyltetracarboxylic acid was charged for 30 min-3 h by dividing it several times. Using 20 mL N,N-dimethylacetamide, 3,3′,4,4′-biphenyltetracarboxylic acid attached to a powder funnel was washed and put into the reaction system. After stirring for 1 h, 25.58 g N,N-dimethylacetamide pyromelliticdianhydride solution (6 wt %) was dropped for 30 min and further stirred for 1 h, so that a polyamic acid was obtained. Next, 0.10 wt % silica with an average diameter of 0.50 μm from which a particle diameter of smaller than 0.08 μm and 2 μm or greater was excluded was added to it and sufficiently stirred and dispersed. Then, the polyamic acid solution was cooled to −5° C., and 15 wt % acetic anhydride and 15 wt % β-picoline were mixed with 100 wt % polyamic acid solution, so that the polyamic acid was imidated.

The polyimide polymer obtained in this manner was cast for 30 sec on a rotary drum at 90° C., and the gel film obtained was stretched 1.1 times in the running direction while heating 100° C. for 5 min. Then, both of its ends in the width direction were gripped, and the film was stretched 1.5 times in the width direction while heating at 270° C. for 2 min and then heated at 380° C. for 5 min, so that a polyimide film with a thickness of 38 μm was obtained. The polyimide film was tensioned at 20 N/m in a furnace set to 220° C. and annealed for 1 min, and its respective characteristics were evaluated and described in Table 3.

### Application Example 8

8.81 g (39 mmol) 4,4′-diaminobenzanilide and 84.73 g N,N-dimethylacetamide were put into a 500 mL separable flask with a DC stirrer and stirred at room temperature in a nitrogen atmosphere. 11.06 g (38 mmol) 3,3′,4,4′-biphenyltetracarboxylic acid was charged for 30-50 min by dividing it several times. Using 10 mL N,N-dimethylacetamide, 3,3′,4,4′-biphenyltetracarboxylic acid attached to a powder funnel was washed and put into the reaction system. After stirring for 1 h, 2.79 g (26 mmol) p-phenylenediamine was added to it, and 7.37 g (25 mmol) 3,3′,4,4′-biphenyltetracarboxylic acid was charged for 10 min into it. Using 10 mL N,N-dimethylacetamide, 3,3′,4,4′-biphenyltetracarboxylic acid attached to the powder funnel was washed and put into the reaction system. After stirring for 12 h, 10.04 g N,N-dimethylacetamide pyromelliticdianhydride solution (6 wt %) was dropped for 30 min and further stirred for 1 h, so that a polyamic acid was obtained. Next, 0.10 wt % silica with an average diameter of 0.50 μm from which a particle diameter of smaller than 0.08 μm and 2 μm or greater was excluded was added to it and sufficiently stirred and dispersed. Then, the polyamic acid solution was cooled to −5° C., and 15 wt % acetic anhydride and 15 wt % β-picoline were mixed with 100 wt % polyamic acid solution, so that the polyamic acid was imidated.

The polyimide polymer obtained in this manner was cast for 30 sec on a rotary drum at 90° C., and the gel film obtained was stretched 1.1 times in the running direction while heating 100° C. for 5 min. Then, both of its ends in the width direction were gripped, and the film was stretched 1.5 times in the width direction while heating at 270° C. for 2 min and then heated at 380° C. for 5 min, so that a polyimide film with a thickness of 38 μm was obtained. The polyimide film was tensioned at 20 N/m in a furnace set to 220° C. and annealed for 1 min, and its respective characteristics were evaluated and described in Table 3.

### Application Example 9

9.23 g (41 mmol) 4,4′-diaminobenzanilide and 84.41 g N,N-dimethylacetamide were put into 500 mL separable flask with a DC stirrer and stirred at room temperature in a nitrogen atmosphere. 8.59 g (39 mmol) pyromellitic dianhydride was charged for 30-50 min by dividing it several times. Using 5 mL N,N-dimethylacetamide, pyromellitic acid attached to a powder funnel was washed and put into the reaction system. After stirring for 2 h, 5.42 g (27 mmol) 4,4′-diaminodiphenyl ether and 5 mL N,N-dimethylacetamide were added to it. 3.98 g (14 mmol) 3,3′,4,4′-biphenyltetracarboxylic acid was charged by dividing it several times. Using 10 mL N,N-dimethylacetamide, 3,3′,4,4′-biphenyltetracarboxylic acid attached to the powder funnel was washed and put into the reaction system. After stirring for 30 min, 2.78 g (13 mmol) pyromellitic dianhydride was charged by dividing it several times. Using 10 mL N,N-dimethylacetamide, the pyromellitic acid attached to the powder funnel was washed and put into the reaction system. After stirring for 16 h, 14.77 g N,N-dimethylacetamide pyromelliticdianhydride solution (6 wt %) was dropped for 30 min and further stirred for 1 h, so that a polyamic acid was obtained. Next, 0.10 wt % silica with an average diameter of 0.50 μm, from which particle diameters smaller than 0.08 μm or greater than 2 μm were excluded, was added to it and sufficiently stirred and dispersed. Then, the polyamic acid solution was cooled to −5° C., and 15 wt % acetic anhydride and 15 wt % β-picoline were mixed with 100 wt % polyamic acid solution, so that the polyamic acid was imidated.

The polyimide polymer obtained in this manner was cast for 30 sec on a rotary drum at 90° C., and the gel film obtained was stretched 1.1 times in the running direction while heating 100° C. for 5 min. Then, both of its ends in the width direction were gripped, and the film was stretched 1.5 times in the width direction while heating at 270° C. for 2 min and then heated at 380° C. for 5 min, so that a polyimide film with a thickness of 38 μm was obtained. The polyimide film was tensioned at 20 N/m in a furnace set to 220° C. and annealed for 1 min, and its respective characteristics were evaluated and described in Table 3.

### Application Example 10

26.66 g (117 mmol) 4,4′-diaminobenzanilide and 195.48 g N,N-dimethylacetamide were put into a 500 mL separable flask with a DC stirrer and stirred at room temperature in a nitrogen atmosphere. 33.47 g (114 mmol) 3,3′,4,4′-biphenyltetracarboxylic acid was charged for 30 min-3 h by dividing it into several times. Using 20 mL N,N-dimethylacetamide, 3,3′,4,4′-biphenyltetracarboxylic acid attached to a powder funnel was washed and put into the reaction system. After stirring for 1 h, 25.58 g N,N-dimethylacetamide pyromelliticdianhydride solution (6 wt %) was dropped for 30 min and further stirred for 1 h, so that a polyamic acid was obtained.

Next, 0.15 wt % silica with an average diameter of 0.50 μm, from which particle diameters smaller than 0.08 μm or greater than 2 μm were excluded, was added to it and sufficiently stirred and dispersed. Then, the polyamic acid solution was cooled to −5° C., and 15 wt % acetic anhydride and 15 wt % β-picoline were mixed with 100 wt % polyamic acid solution, so that the polyamic acid was imidated.

The polyimide polymer obtained in this manner was cast for 30 sec on a rotary drum at 90° C., and the gel film obtained was stretched 1.1 times in the running direction while heating 100° C. for 5 min. Then, its both ends in the width direction were gripped, and the film was stretched 1.5 times in the width direction while heating at 270° C. for 2 min and then heated at 380° C. for 5 min, so that a polyimide film with a thickness of 38 μm was obtained. The polyimide film was tensioned at 20 N/m in a furnace set to 220° C. and annealed for 1 min, and its respective characteristics were evaluated and described in Table 4.

### Application Example 11

8.81 g (39 mmol) 4,4′-diaminobenzanilide and 84.73 g N,N-dimethylacetamide were put into 500 mL separable flask with a DC stirrer and stirred at room temperature in a nitrogen atmosphere. 11.06 g (38 mmol) 3,3′,4,4′-biphenyltetracarboxylic acid was charged for 30-50 min by dividing it into several times. Using 10 mL N,N-dimethylacetamide, 3,3′,4,4′-biphenyltetracarboxylic acid attached to a powder funnel was washed and put into the reaction system. After stirring for 1 h, 2.79 g (26 mmol) p-phenylenediamine was added to it, and 7.37 g (25 mmol) 3,3′,4,4′-biphenyltetracarboxylic acid was charged for 10 min into it. Using 10 mL N,N-dimethylacetamide, 3,3′,4,4′-biphenyltetracarboxylic acid attached to the powder funnel was washed and put into the reaction system. After stirring for 12 h, 10.04 g N,N-dimethylacetamide pyromelliticdianhydride solution (6 wt %) was dropped for 30 min and further stirred for 1 h, so that a polyamic acid was obtained.

Next, 0.15 wt % silica with an average diameter of 0.50 μm, from which particle diameters smaller than 0.08 μm or greater than 2 μm were excluded, was added to it and sufficiently stirred and dispersed. Then, the polyamic acid solution was cooled to −5° C., and 15 wt % acetic anhydride and 15 wt % β-picoline were mixed with 100 wt % polyamic acid solution, so that the polyamic acid was imidated.

The polyimide polymer obtained in this manner was cast for 30 sec on a rotary drum at 90° C., and the gel film obtained was stretched 1.1 times in the running direction while heating 100° C. for 5 min. Then, its both ends in the width direction were gripped, and the film was stretched 1.5 times in the width direction while heating at 270° C. for 2 min and than heated at 380° C. for 5 min, so that a polyimide film with a thickness of 38 μm was obtained. The polyimide film was tensioned at 20 N/m in a furnace set to 220° C. and annealed for 1 min, and its respective characteristics were evaluated and described in Table 4.

### Application Example 12

9.23 g (41 mmol) 4,4′-diaminobenzanilide and 84.41 g N,N-dimethylacetamide were put into a 500 mL separable flask with a DC stirrer and stirred at room temperature in a nitrogen atmosphere. 8.59 g (39 mmol) pyromellitic dianhydride was charged for 30-50 min by dividing it several times. Using 5 mL N,N-dimethylacetamide, pyromellitic acid attached to a powder funnel was washed and put into the reaction system. After stirring for 2 h, 5.42 g (27 mmol) 4,4′-diaminodiphenyl ether and 5 mL N,N-dimethylacetamide were added to it. 3.98 g (14 mmol) 3,3′,4,4′-biphenyltetracarboxylic acid was charged by dividing it several times. Using 10 mL N,N-dimethylacetamide, 3,3′,4,4′-biphenyltetracarboxylic acid attached to the powder funnel was washed and put into the reaction system. After stirring for 30 min, 2.78 g (13 mmol) pyromellitic dianhydride was charged by dividing it several times. Using 10 mL N,N-dimethylacetamide, the pyromellitic acid attached to the powder funnel was washed and put into the reaction system.

After stirring for 16 h, 14.77 g N,N-dimethylacetamide pyromelliticdianhydride solution (6 wt %) was dropped for 30 min and further stirred for 1 h, so that a polyamic acid was obtained. Next, 0.15 wt % silica with an average diameter of 0.50 μm, from which particle diameters smaller than 0.08 μm or greater than 2 μm were excluded, was added to it and sufficiently stirred and dispersed. Then, the polyamic acid solution was cooled to −5° C., and 15 wt % acetic anhydride and 15 wt % β-picoline were mixed with 100 wt % polyamic acid solution, so that the polyamic acid was imidated.

The polyimide polymer obtained in this manner was cast for 30 sec on a rotary drum at 90° C., and the gel film obtained was stretched 1.1 times in the running direction while heating 100° C. for 5 min. Then, both of its ends in the width direction were gripped, and the film was stretched 1.5 times in the width direction while heating at 270° C. for 2 min and then heated at 380° C. for 5 min, so that a polyimide film with a thickness of 38 μm was obtained. The polyimide film was tensioned at 20 N/m in a furnace set to 220° C. and annealed for 1 min, and its respective characteristics were evaluated and described in Table 4.

### Application Example 13

26.66 g (117 mmol) 4,4′-diaminobenzanilide and 195.48 g N,N-dimethylacetamide were put into a 500 mL separable flask with a DC stirrer and stirred at room temperature in a nitrogen atmosphere. 33.47 g (114 mmol) 3,3′,4,4′-biphenyltetracarboxylic acid was charged for 30 min-3 h by dividing it several times. Using 20 mL N,N-dimethylacetamide, 3,3′,4,4′-biphenyltetracarboxylic acid attached to a powder funnel was washed and put into the reaction system. After stirring for 1 h, 25.58 g N,N-dimethylacetamide pyromelliticdianhydride solution (6 wt %) was dropped for 30 min and further stirred for 1 h, so that a polyamic acid was obtained.

Next, 0.10 wt % silica with an average diameter of 0.70 μm, from which particle diameters smaller than 0.08 μm or greater than 2 μm were excluded, was added to it and sufficiently stirred and dispersed. Then, the polyamic acid solution was cooled to −5° C., and 15 wt % acetic anhydride and 15 wt % β-picoline were mixed with 100 wt % polyamic acid solution, so that the polyamic acid was imidated.

The polyimide polymer obtained in this manner was cast for 30 sec on a rotary drum at 90° C., and the gel film obtained was stretched 1.1 times in the running direction while heating 100° C. for 5 min. Then, both of its ends in the width direction were gripped, and the film was stretched 1.5 times in the width direction while heating at 270° C. for 2 min and heated 380° C. for 5 min, so that a polyimide film with a thickness of 38 μm was obtained. The polyimide film was tensioned at 20 N/m in a furnace set to 220° C. and annealed for 1 min, and its respective characteristics were evaluated and described in Table 5.

### Application Example 14

8.81 g (39 mmol) 4,4′-diaminobenzanilide and 84.73 g N,N-dimethylacetamide were put into 500 mL separable flask with a DC stirrer and stirred at room temperature in a nitrogen atmosphere. 11.06 g (38 mmol) 3,3′,4,4′-biphenyltetracarboxylic acid was charged for 30-50 min by dividing it several times. Using 10 mL N,N-dimethylacetamide, 3,3′,4,4′-biphenyltetracarboxylic acid attached to a powder funnel was washed and put into the reaction system. After stirring for 1 h, 2.79 g (26 mmol) p-phenylenediamine was added to it, and 7.37 g (25 mmol) 3,3′,4,4′-biphenyltetracarboxylic acid was charged for 10 min into it. Using 10 mL N,N-dimethylacetamide, 3,3′,4,4′-biphenyltetracarboxylic acid attached to the powder funnel was washed and put into the reaction system. After stirring for 12 h, 10.04 g N,N-dimethylacetamide pyromelliticdianhydride solution (6 wt %) was dropped for 30 min and further stirred for 1 h, so that a polyamic acid was obtained.

Next, 0.10 wt % silica with an average diameter of 0.70 μm, from which particle diameters smaller than 0.08 μm or greater than 2 μm were excluded, was added to it and sufficiently stirred and dispersed. Then, the polyamic acid solution was cooled to −5° C., and 15 wt % acetic anhydride and 15 wt % β-picoline were mixed with 100 wt % polyamic acid solution, so that the polyamic acid was imidated.

The polyimide polymer obtained in this manner was cast for 30 sec on a rotary drum at 90° C., and the gel film obtained was stretched 1.1 times in the running direction while heating 100° C. for 5 min. Then, both of its ends in the width direction were gripped, and the film was stretched 1.5 times in the width direction while heating at 270° C. for 2 min and heated 380° C. for 5 min, so that a polyimide film with a thickness of 38 μm was obtained. The polyimide film was tensioned at 20 N/m in a furnace set to 220° C. and annealed for 1 min, and its respective characteristics were evaluated and described in Table 5.

### Application Example 15

9.23 g (41 mmol) 4,4′-diaminobenzanilide and 84.41 g N,N-dimethylacetamide were put into a 500 mL separable flask with a DC stirrer and stirred at room temperature in a nitrogen atmosphere. 8.59 g (39 mmol) pyromellitic dianhydride was charged for 30-50 min by dividing it several times. Using 5 mL N,N-dimethylacetamide, pyromellitic acid attached to a powder funnel was washed and put into the reaction system. After stirring for 2 h, 5.42 g (27 mmol) 4,4′-diaminodiphenyl ether and 5 mL N,N-dimethylacetamide were added to it. 3.98 g (14 mmol) 3,3′,4,4′-biphenyltetracarboxylic acid was charged by dividing it several times. Using 10 mL N,N-dimethylacetamide, 3,3′,4,4′-biphenyltetracarboxylic acid attached to the powder funnel was washed and put into the reaction system. After stirring for 30 min, 2.78 g (13 mmol) pyromellitic dianhydride was charged by dividing it several times. Using 10 mL N,N-dimethylacetamide, the pyromellitic acid attached to the powder funnel was washed and put into the reaction system.

After stirring for 16 h, 14.77 g N,N-dimethylacetamide pyromelliticdianhydride solution (6 wt %) was dropped for 30 min and further stirred for 1 h, so that a polyamic acid was obtained. Next, 0.10 wt % silica with an average diameter of 0.70 μm, from which particle diameters smaller than 0.08 μm or greater than 2 μm were excluded, was added to it and sufficiently stirred and dispersed. Then, the polyamic acid solution was cooled to −5° C., and 15 wt % acetic anhydride and 15 wt % β-picoline were mixed with 100 wt % polyamic acid solution, so that the polyamic acid was imidated.

The polyimide polymer obtained in this manner was cast for 30 sec on a rotary drum at 90° C., and the gel film obtained was stretched 1.1 times in the running direction while heating 100° C. for 5 min. Then, both of its ends in the width direction were gripped, and the film was stretched 1.5 times in the width direction while heating at 270° C. for 2 min and heated 380° C. for 5 min, so that a polyimide film with a thickness of 38 μm was obtained. The polyimide film was tensioned at 20 N/m in a furnace set to 220° C. and annealed for 1 min, and its respective characteristics were evaluated and described in Table 5.

### Comparative Example 1

24.78 g (123.7 mmol) 4,4′-diaminobenzanilide and 219 g N,N-dimethylacetamide were put into 500 mL separable flask with a DC stirrer and stirred at room temperature in a nitrogen atmosphere. 15.31 g (120 mmol) 3,3′,4,4′-biphenyltetracarboxylic acid was charged for 30 min-50 min by dividing it several times. Using 10 mL N,N-dimethylacetamide, pyromellitic acid attached to a powder funnel was washed and put into the reaction system. After stirring for 2 h, 13.48 g N,N-dimethylacetamide pyromelliticdianhydride solution (6 wt %) was dropped for 30 min and further stirred for 1 h, so that a polyamic acid was obtained.

Next, 0.03 wt % silica with an average diameter of 0.30 μm from which particle diameters smaller than 0.08 μm or greater than 2 μm were excluded, was added to it and sufficiently stirred and dispersed. Then, the polyamic acid solution was cooled to −5° C., and 15 wt % acetic anhydride and 15 wt % β-picoline were mixed with 100 wt % polyamic acid solution, so that the polyamic acid was imidated.

The polyimide polymer obtained in this manner was cast for 30 sec on a rotary drum at 90° C., and the gel film obtained was stretched 1.1 times in the running direction while heating at 100° C. for 5 min. Then, its both ends in the width direction were gripped, and the film was stretched 1.5 times in the width direction while heating at 270° C. for 2 min and then heated at 380° C. for 5 min, so that a polyimide film with a thickness of 38 μm was obtained. The polyimide film was tensioned at 20 N/m in a furnace set to 220° C. and annealed for 1 min, and its respective characteristics were evaluated and described in Table 6.

### Comparative Example 2

4.53 g (42 mmol) p-phenylenediamine, 21.53 g (107.5 mmol) 4,4′-diaminodiphenyl ether, and 239.1 g N,N-dimethylacetamide were put into 500 mL separable flask with a DC stirrer and stirred at room temperature in a nitrogen atmosphere. 8.79 g (29.8 mmol) 3,3′,4,4′-biphenyltetracarboxylic acid was charged for 30-50 min by dividing it several times. Using 10 mL N,N-dimethylacetamide, 3,3′,4,4′-biphenyltetracarboxylic acid attached to a powder funnel was washed and put into the reaction system. After stirring for 2 h, 26.06 g (115.0 mmol) pyromellitic dianhydride and 16.28 g N,N-dimethylacetamide solution (6 wt %) were dropped for 30 min and further stirred for 1 h, so that a polyamic acid was obtained.

Next, 0.03 wt % silica with an average diameter of 0.30 μm, from which particle diameters smaller than 0.08 μm or greater than 2 μm were excluded, was added to it and sufficiently stirred and dispersed. Then, the polyamic acid solution was cooled to −5° C., and 15 wt % acetic anhydride and 15 wt % β-picoline were mixed with 100 wt % polyamic acid solution, so that the polyamic acid was imidated.

The polyimide polymer obtained in this manner was cast for 30 sec on a rotary drum at 90° C., and the gel film obtained was stretched 1.1 times in the running direction while heating 100° C. for 5 min. Then, both of its ends in the width direction were gripped, and the film was stretched 1.5 times in the width direction while heating at 270° C. for 2 min and heated 380° C. for 5 min, so that a polyimide film with a thickness of 38 μm was obtained. The polyimide film was tensioned at 20 N/m in a furnace set to 220° C. and annealed for 1 min, and its respective characteristics were evaluated and described in Table 6.

### Comparative Example 3

17.04 g (85.1 mmol) 4,4′-diaminodiphenyl ether, 12.90 g (56.7 mmol) 4,4′-diaminobenzanilide, and 219 g N,N-dimethylacetamide were put into 500 mL separable flask with a DC stirrer and stirred at room temperature in a nitrogen atmosphere. 15.31 g (120 mmol) 3,3′,4,4′-biphenyltetracarboxylic acid was charged for 30-50 min by dividing it into several times. Using 10 mL N,N-dimethylacetamide, pyromellitic acid attached to a powder funnel was washed and put into the reaction system. After stirring for 2 h, 13.48 g N,N-dimethylacetamide pyromelliticdianhydride solution (6 wt %) was dropped for 30 min and further stirred for 1 h, so that a polyamic acid was obtained.

Next, 0.03 wt % silica with an average diameter of 0.30 μm from which a particle diameter of smaller than 0.08 μm and 2 μm or greater was excluded was added to it and sufficiently stirred and dispersed. Then, the polyamic acid solution was cooled to −5° C., and 15 wt % acetic anhydride and 15 wt % β-picoline were mixed with 100 wt % polyamic acid solution, so that the polyamic acid was imidated.

The polyimide polymer obtained in this manner was cast for 30 sec on a rotary drum at 90° C., and the gel film obtained was stretched 1.1 times in the running direction while heating at 100° C. for 5 min. Then, its both ends in the width direction were gripped, and the film was stretched 1.5 times in the width direction while heating at 270° C. for 2 min and then heated at 380° C. for 5 min, so that a polyimide film with a thickness of 38 μm was obtained. The polyimide film was tensioned at 20 N/m in a furnace set to 220° C. and annealed for 1 min, and its respective characteristics were evaluated and described in Table 6.

TABLE 1

| | | | Application Example | | |
|---|---|---|---|---|---|
| | | | | 2 | 3 |
| | | | 1 | DABA: 60 | DABA: 60 |
| | | | DABA: 100 | PPD: 40 | ODA: 40 |
| | | | BPDA: 97 | BPDA: 97 | PMDA: 80 |
| | | | PMDA: 3 | PMDA: 3 | BPDA: 20 |
| Stretch magnitude | (MDX) | | 1.1 | 1.1 | 1.1 |
| | (TDX) | | 1.5 | 1.5 | 1.5 |
| Thermal expansion | (MD) | ppm/° C. | 5.8 | 6.8 | 2.9 |
| coefficient | (TD) | | 5.6 | 7.0 | 2.5 |
| Thermal contraction rate | (MD) | % | 0.02 | 0.02 | 0.02 |
| | (TD) | | 0.02 | 0.02 | 0.02 |
| Tensile elastic modulus | (MD) | GPa | 7.6 | 7.2 | 7.1 |
| | (TD) | | 7.8 | 7.5 | 6.9 |

| | | | | |
|---|---|---|---|---|
| Amount of silica added | wt % | 0.03 | 0.03 | 0.03 |
| Flow velocity distribution | μm | 0.08~2.0 | 0.08~2.0 | 0.08~2.0 |
| Average particle diameter | μm | 0.30 | 0.30 | 0.30 |
| Number of projections | pieces/mm² | 3.2 × 10⁵ | 3.2 × 10⁵ | 3.2 × 10⁵ |
| Size change rate | % | 0.02 | 0.02 | 0.02 |
| Curl | mm | 2.5 | 2.5 | 2.5 |
| Friction coefficient | | 0.91 | 0.92 | 0.91 |

TABLE 2

| | | | Application Example | | |
|---|---|---|---|---|---|
| | | | | 5 | 6 |
| | | | 4 | DABA: 60 | DABA: 60 |
| | | | DABA: 100 | PPD: 40 | ODA: 40 |
| | | | BPDA: 97 | BPDA: 97 | PMDA: 80 |
| | | | PMDA: 3 | PMDA: 3 | BPDA: 20 |
| Stretch magnitude | (MDX) | | 1.1 | 1.1 | 1.1 |
| | (TDX) | | 1.5 | 1.5 | 1.5 |
| Thermal expansion | (MD) | ppm/° C. | 5.8 | 6.8 | 2.9 |
| coefficient | (TD) | | 5.6 | 7.0 | 2.5 |
| Thermal contraction rate | (MD) | % | 0.02 | 0.02 | 0.02 |
| | (TD) | | 0.02 | 0.02 | 0.02 |
| Tensile elastic modulus | (MD) | GPa | 7.6 | 7.2 | 7.1 |
| | (TD) | | 7.8 | 7.5 | 6.9 |

| | | | | |
|---|---|---|---|---|
| Amount of silica added | wt % | 0.10 | 0.10 | 0.10 |
| Flow velocity distribution | μm | 0.08~2.0 | 0.08~2.0 | 0.08~2.0 |
| Average particle diameter | μm | 0.30 | 0.30 | 0.30 |
| Number of projections | pieces/mm² | 9.3 × 10⁵ | 9.2 × 10⁵ | 9.3 × 10⁵ |
| Size change rate | % | 0.02 | 0.02 | 0.02 |
| Curl | mm | 2.5 | 2.5 | 2.5 |
| Friction coefficient | | 0.71 | 0.72 | 0.71 |

TABLE 3

| | | | Application Example | | |
|---|---|---|---|---|---|
| | | | | 8 | 9 |
| | | | 7 | DABA: 60 | DABA: 60 |
| | | | DABA: 100 | PPD: 40 | ODA: 40 |
| | | | BPDA: 97 | BPDA: 97 | PMDA: 80 |
| | | | PMDA: 3 | PMDA: 3 | BPDA: 20 |
| Stretch magnitude | (MDX) | | 1.1 | 1.1 | 1.1 |
| | (TDX) | | 1.5 | 1.5 | 1.5 |
| Thermal expansion | (MD) | ppm/° C. | 5.8 | 6.8 | 2.9 |
| coefficient | (TD) | | 5.6 | 7.0 | 2.5 |
| Thermal contraction rate | (MD) | % | 0.02 | 0.02 | 0.02 |
| | (TD) | | 0.02 | 0.02 | 0.02 |
| Tensile elastic modulus | (MD) | GPa | 7.6 | 7.2 | 7.1 |
| | (TD) | | 7.8 | 7.5 | 6.9 |

| | | | | |
|---|---|---|---|---|
| Amount of silica added | wt % | 0.10 | 0.10 | 0.10 |
| Flow velocity distribution | μm | 0.08~2.0 | 0.08~2.0 | 0.08~2.0 |
| Average particle diameter | μm | 0.50 | 0.50 | 0.50 |
| Number of projections | pieces/mm² | 7.7 × 10⁵ | 7.7 × 10⁵ | 7.7 × 10⁵ |
| Size change rate | % | 0.02 | 0.02 | 0.02 |
| Curl | mm | 2.5 | 2.5 | 2.5 |
| Friction coefficient | | 0.75 | 0.75 | 0.75 |

TABLE 4

| | | | Application Example | | |
|---|---|---|---|---|---|
| | | | | 11 | 12 |
| | | | 10 | DABA: 60 | DABA: 60 |
| | | | DABA: 100 | PPD: 40 | ODA: 40 |
| | | | BPDA: 97 | BPDA: 97 | PMDA: 80 |
| | | | PMDA: 3 | PMDA: 3 | BPDA: 20 |
| Stretch magnitude | (MDX) | | 1.1 | 1.1 | 1.1 |
| | (TDX) | | 1.5 | 1.5 | 1.5 |
| Thermal expansion | (MD) | ppm/° C. | 5.8 | 6.8 | 2.9 |
| coefficient | (TD) | | 5.6 | 7.0 | 2.5 |
| Thermal contraction rate | (MD) | % | 0.02 | 0.02 | 0.02 |
| | (TD) | | 0.02 | 0.02 | 0.02 |
| Tensile elastic modulus | (MD) | GPa | 7.6 | 7.2 | 7.1 |
| | (TD) | | 7.8 | 7.5 | 6.9 |

| | | | | |
|---|---|---|---|---|
| Amount of silica added | wt % | 0.15 | 0.15 | 0.15 |
| Flow velocity distribution | μm | 0.08~2.0 | 0.08~2.0 | 0.08~2.0 |
| Average particle diameter | μm | 0.50 | 0.50 | 0.50 |
| Number of projections | pieces/mm² | 1.2 × 10⁵ | 1.2 × 10⁵ | 1.2 × 10⁵ |
| Size change rate | % | 0.02 | 0.02 | 0.02 |
| Curl | mm | 2.5 | 2.5 | 2.5 |
| Friction coefficient | | 0.42 | 0.42 | 0.42 |

TABLE 5

| | | | Application Example | | |
|---|---|---|---|---|---|
| | | | | 14 | 15 |
| | | | 13 | DABA: 60 | DABA: 60 |
| | | | DABA: 100 | PPD: 40 | ODA: 40 |
| | | | BPDA: 97 | BPDA: 97 | PMDA: 80 |
| | | | PMDA: 3 | PMDA: 3 | BPDA: 20 |
| Stretch magnitude | (MDX) | | 1.1 | 1.1 | 1.1 |
| | (TDX) | | 1.5 | 1.5 | 1.5 |
| Thermal expansion | (MD) | ppm/° C. | 5.8 | 6.8 | 2.9 |
| coefficient | (TD) | | 5.6 | 7.0 | 2.5 |
| Thermal contraction rate | (MD) | % | 0.02 | 0.02 | 0.02 |
| | (TD) | | 0.02 | 0.02 | 0.02 |
| Tensile elastic modulus | (MD) | GPa | 7.6 | 7.2 | 7.1 |
| | (TD) | | 7.8 | 7.5 | 6.9 |

| | | | | |
|---|---|---|---|---|
| Amount of silica added | wt % | 0.10 | 0.10 | 0.10 |
| Flow velocity distribution | μm | 0.08~2.0 | 0.08~2.0 | 0.08~2.0 |
| Average particle diameter | μm | 0.70 | 0.70 | 0.70 |
| Number of projections | pieces/mm² | 5.8 × 10⁵ | 5.8 × 10⁵ | 5.8 × 10⁵ |
| Size change rate | % | 0.02 | 0.02 | 0.02 |
| Curl | mm | 2.5 | 2.5 | 2.5 |
| Friction coefficient | | 0.51 | 0.51 | 0.51 |

TABLE 6

| | | | Comparative Example | | |
|---|---|---|---|---|---|
| | | | | 2 | 3 |
| | | | 1 | PPD: 28 | DABA: 40 |
| | | | 4,4′-ODA: 100 | 4,4′-ODA: 72 | ODA: 60 |
| | | | BPDA: 97 | BPDA: 20 | BPDA: 97 |
| | | | PMDA: 3 | PMDA: 80 | PMDA: 3 |
| Stretch magnitude | (MDX) | | 1.1 | 1.1 | 1.1 |
| | (TDX) | | 1.5 | 1.5 | 1.5 |
| Thermal expansion | (MD) | ppm/° C. | 30.6 | 15.8 | 14.8 |
| coefficient | (TD) | | 31.5 | 4.8 | 15.6 |
| Thermal contraction rate | (MD) | % | 0.02 | 0.02 | 0.03 |
| | (TD) | | 0.02 | 0.02 | 0.04 |
| Tensile elastic modulus | (MD) | GPa | 3.1 | 6.0 | 5.6 |
| | (TD) | | 3.5 | 6.6 | 5.8 |

| | | | | |
|---|---|---|---|---|
| Amount of silica added | wt % | 0.03 | 0.03 | 0.03 |
| Flow velocity distribution | μm | 0.08~2.0 | 0.08~2.0 | 0.08~2.0 |
| Average particle diameter | μm | 0.30 | 0.30 | 0.30 |
| Number of projections | pieces/mm² | 3.2 × 10⁵ | 3.2 × 10⁵ | 3.2 × 10⁵ |
| Size change rate | % | 0.15 | 0.12 | 0.12 |
| Curl | mm | 6.5 | 4.5 | 3.3 |
| Friction coefficient | | 0.90 | 0.90 | 0.90 |

In Application Examples 1-3 shown in Table 1, 50 mol % DABA was added, and the amount of other acid dianhydride and diamine was changed. As a result, a thermal expansion coefficient of 1-10 ppm/° C. was achieved in Application Examples 1-3. Also, in Claims 1 and 3, 0-7 ppm/° C. described in Claim 2 was achieved. Also, in the tensile elastic modulus, the value described in Claim 3 could be achieved.

Also, silica particles were added within the condition range described in Claim 4. As a result, the number of projections was 3.1×10⁵ to 3.2×10⁵ pieces, and 1×10³ to 1×10⁸ pieces described in Claim 7 could be achieved.

In Application Examples 4-6 shown in Table 2, the amount of addition of the silica was increased from 0.03% of 1-3 described in Table 1 to 0.10%. As a result, as the number of projections was increased to 9.2×10⁵ to 9.3×10⁸ pieces, while the friction coefficient was also lowered to 0.71-0.72.

In Application Examples 7-9 shown in Table 3, the average particle diameter of the silica particles was changed from 0.03 μm to 0.05 Mm, and the amount of addition was set to 0.10% similarly to Application Examples 4-6. As a result, the number of projections was reduced to 7.7×10⁵, and along with it, the friction coefficient was increased to 0.75.

In Application Examples 10-12 shown in Table 4, the average particle diameter of the silica particles was set to 0.05 μm similarly to Application Examples 7-9, and the amount of addition was set to 0.15%. As a result, the number of projections was reduced to 5.8×10⁵, and along with it, the friction coefficient was increased to 0.42.

In Table 5, the amount of addition was set to 0.10% similarly to Application Examples 4-6, and the average particle diameter was set to 0.07 μm. As a result, the number of projections was reduced to 5.8×10⁵, and along with it, the friction coefficient was increased to 0.51.

In Table 5, the linear expansion coefficient of 0-10 ppm/° C. of claim 1 could not be achieved in the composition in which 4,4′-diaminobenzanilide was not added in Comparative Examples 1 and 2. Also, 40 mol % 4,4′-diaminobenzanilide was added. In Comparative Example 3, 0-10 ppn/° C. of claim 1 could not be achieved.

### INDUSTRIAL APPLICABILITY

Since the polyimide film of the present invention has excellent size stability, it can be appropriately used for a substrate for fine pitch circuits, especially COF (Chip on Film) being wired at a narrow pitch of the film.

### Solution Means

A polyimide film characterized by the fact that at least 50 mol % or more 4,4-diaminobenzanilide is used as a diamine component; and the thermal expansion coefficient α_{MD} in the machine carrying direction (MD) of a film and the thermal expansion coefficient α_{TD} in the width direction (TD) are in a range of 0-10 ppm/° C., and a copper-clad laminate characterized by the fact that the above-mentioned polyimide film is used as a base material and copper with a thickness of 1-10 μm is formed on the polyimide film.

What is claimed is:

1. A polyimide film, characterized by the fact that at least 50 mol % or more 4,4-diaminobenzanilide represented by a formula (I) is used as a diamine component; and the thermal expansion coefficient α_{MD} in the machine carrying direction (MD) of a film and the thermal expansion coefficient α_{TD} in the width direction (TD) are in a range of 0-10 ppm/° C.

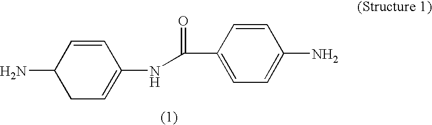

2. The polyimide film of claim 1, characterized by the fact that the thermal expansion coefficient α_{MD} in the machine carrying direction (MD) of the film and the thermal expansion coefficient α_{TD} in the width direction (TD) are in a range of 0-7 ppm/° C.

3. The polyimide film of claim 1 or 2, characterized by the fact that the tensile elastic modulus is 5.0 GPa or more.

4. The polyimide film of any of claims 1-3, characterized by the fact that inorganic particles with a particle diameter of 0.07-2.0 μm are uniformly dispersed at a ratio of 0.03-0.30 wt % to the film resin weight into the film; and fine projections are formed on the surface.

5. The polyimide film of claim 4, characterized by the fact that the average particle diameter of the inorganic particles is 0.10-0.90 μm.

6. The polyimide film of claim 5, characterized by the fact that the average particle diameter of the inorganic particles is 0.10-0.30 μm.

7. The polyimide film of any of claims 4-6, characterized by the fact that the number of projections being formed by the inorganic particles is 1×10³ to 1×10⁸ pieces per 1 mm².

8. A copper-clad laminate, characterized by the fact that the polyimide film of any of claims 1-7 is used as a base material; and copper with a thickness of 1-10 μm is formed on it.
